(19) United States
(12) Patent Application Publication
(10) Pub. No.: US 2026/0208759 A1
(43) Pub. Date: Jul. 23, 2026

(54) SYSTEMS AND METHODS FOR QUANTIFYING COMPLEXITY OF EXTERNAL ENVIRONMENTS FOR VEHICLES AND TESTING THEREOF

(71) Applicant: GM GLOBAL TECHNOLOGY OPERATIONS LLC, Detroit, MI (US)

(72) Inventors: Eshan Dixit, Farmington Hills, MI (US); Armando Antonio Beltran Pacheco, Rochester Hills, MI (US); Ramesh Sethu, Troy, MI (US); Marcus J. Huber, Saline, MI (US)

(73) Assignee: GM GLOBAL TECHNOLOGY OPERATIONS LLC, Detroit, MI (US)

(21) Appl. No.: 19/032,843

(22) Filed: Jan. 21, 2025

(51) Int. Cl. B60W 60/00; B60W 50/00

(52) U.S. Cl. CPC B60W 60/001; B60W 50/0098; B60W 2050/0022; B60W 2540/30; B60W 2554/20; B60W 2554/40; B60W 2555/20

(57) ABSTRACT

Methods and systems are provided for quantifying complexity of external environments for vehicles and testing of automated driving systems (ADS). The systems include a sensor system including sensing devices configured to sense observable conditions in an external environment outside of the vehicle and a controller in operable communication with the sensor system. The controller is configured to, by one or more processors: receive, from the sensor system, sensor data indicative of the observable conditions in the external environment, process the sensor data to determine static and dynamic attributes of actors in the external environment, generate a complexity score indicative of a complexity of the static and dynamic attributes of the actors in the external environment, and provide the complexity score to one or more other systems of the vehicle to modify operation of the vehicle based on the complexity score.

### INTRODUCTION

The technical field generally relates to vehicle systems, and more particularly relates to automated operation of a vehicle configured for generation and use of complexity scores indicative of a complexity of surrounds about the vehicle.

The operation of modern vehicles is becoming more automated, that is, able to provide driving control with less driver intervention. In general, autonomous vehicles are vehicles that are capable of sensing their environment and navigating with little or no user input. Autonomous vehicles may sense their environment using sensing devices such as radar, lidar, image sensors, and the like. Autonomous vehicles may further use information from global positioning systems (GPS) technology, navigation systems, vehicle-to-vehicle communication, vehicle-to-infrastructure technology, and/or drive-by-wire systems for navigation.

As the industry transitions to autonomous vehicles, various opportunities may arise for improving user experience and safety during autonomous operation of the vehicles. Accordingly, there is an ongoing desire for systems and methods that promote a positive user experience during autonomous vehicle operation. Furthermore, other desirable features and characteristics of the present disclosure will become apparent from the subsequent detailed description and the appended claims, taken in conjunction with the accompanying drawings and the foregoing introduction.

### SUMMARY

A method is provided for quantifying complexity of an external environment for a vehicle. In one example, the method includes, with one or more processors of a controller, receiving sensor data indicative of an external environment outside of a vehicle, processing static and dynamic attributes of actors in the external environment based on the sensor data, generating a complexity score indicative of a complexity of the static and dynamic attributes of the actors in the external environment, and providing the complexity score to one or more other systems of the vehicle to modify operation of the vehicle based on the complexity score.

In various examples, the method may include generating the complexity score by inputting the static and dynamic attributes of the actors in the external environment into a weighted sum model.

In various examples, the static and dynamic attributes of the actors of the method may include a number, type, and dynamic parameters of the actors in the external environment. In various examples, the static and dynamic attributes of the actors include weather conditions.

In various examples, the method may include recording complexity score data indicative of a plurality of complexity scores periodically generated over a period of time indicative of the complexity of the static and dynamic attributes of the actors in the external environment at a time of generation thereof, and generating, with the one or more processors of the controller, a cumulative complexity score indicative of an average of the plurality of complexity scores during the period of time.

In various examples, the method may include providing, with the one or more processors of the controller, the complexity score to a systematic positive reinforcement system of the vehicle to promote specific driver behavior.

In various examples, the method may include processing the static and dynamic attributes of the actors with an automated driving system (ADS) of the vehicle.

In various examples, the method may include providing the complexity score to an automated driving system (ADS) of the vehicle for path planning of the vehicle.

A method is provided for testing an automated driving system (ADS) of a vehicle. In one example, the method includes, with one or more processors of a controller, generating models of driving scenarios that include a vehicle traveling through an external environment outside of the vehicle, wherein the external environment includes a plurality of actors having static and dynamic attributes, generating, with the one or more processors, complexity scores indicative of complexities of the static and dynamic attributes of the plurality of actors in the external environment for each of the driving scenarios, assigning, with the one or more processors, each of the driving scenarios to a corresponding one of two or more categories based on the corresponding complexity scores of each of the driving scenarios, and performing, with the one or more processors, a vehicle simulation test using a first category of the two or more categories in order to test the ADS of the vehicle to evaluate performance of the ADS, wherein the performance of the ADS in the vehicle simulation test is representative of the performance of the ADS in each of the driving scenarios assigned to the first category.

In various examples, the method may include generating the complexity score includes inputting the static and dynamic attributes of the plurality of actors in the external environment into a weighted sum model.

In various examples, the static and dynamic attributes of the plurality of actors of the method may include a number, type, and dynamic parameters of the plurality of actors in the external environment. In various examples, the static and dynamic attributes of the plurality of actors may include weather conditions.

In various examples, the method may include modifying the ADS of the vehicle based on the performance of the ADS in the vehicle simulation test.

In various examples, the two or more categories of the method have different ranges of complexity scores associated therewith and each of the driving scenarios is assigned to one of the two or more categories for which the corresponding complexity score of the driving scenarios falls within the associated range.

A system is provided for quantifying complexity of an external environment for a vehicle. In one example, the system includes a sensor system including sensing devices configured to sense observable conditions in an external environment outside of the vehicle and a controller in operable communication with the sensor system. The controller is configured to, by one or more processors: receive, from the sensor system, sensor data indicative of the observable conditions in the external environment, process the sensor data to determine static and dynamic attributes of actors in the external environment, generate a complexity score indicative of a complexity of the static and dynamic attributes of the actors in the external environment, and provide the complexity score to one or more other systems of the vehicle to modify operation of the vehicle based on the complexity score.

In various examples, the controller may be configured to, with the one or more processors, generate the complexity score by inputting the static and dynamic attributes of the actors in the external environment into a weighted sum model.

In various examples, the static and dynamic attributes of the actors of the system may include a number, type, and dynamic parameters of the actors in the external environment. In various examples, the static and dynamic attributes of the actors include weather conditions.

In various examples, the controller may be configured to, with the one or more processors: record complexity score data indicative of a plurality of complexity scores periodically generated over a period of time indicative of the complexity of the static and dynamic attributes of the actors in the external environment at a time of generation thereof, and generate a cumulative complexity score indicative of an average of the plurality of complexity scores during the period of time.

In various examples, the controller may be configured to, with the one or more processors, provide the complexity score to a systematic positive reinforcement system of the vehicle to promote specific driver behavior.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle having a complexity score system in accordance with an example;

FIG. 2 is a block diagram of an automated driving system (ADS) suitable for implementation by the vehicle of FIG. 1 in accordance with an example; and

FIG. 3 is a dataflow diagram of systems of the vehicle of FIG. 1 including the complexity score system in accordance with an example;

FIG. 4 represents a first external environment and corresponding complexity scores generated by the complexity score system of FIG. 1 in accordance with an example;

FIG. 5 represents a second external environment and corresponding complexity scores generated by the complexity score system of FIG. 1 in accordance with an example;

FIG. 6 represents a third external environment and corresponding complexity scores generated by the complexity score system of FIG. 1 in accordance with an example;

FIG. 7 depicts a flow diagram of an exemplary method for determining and using a complexity score in accordance with an example;

FIG. 8 depicts a flow diagram of an method for generating and categorizing models of driving scenarios and corresponding complexity scores for use in vehicle system testing in accordance with an example; and

FIG. 9 schematically represents various scenarios and corresponding complexity scores grouped in categories in accordance with an example.

### DETAILED DESCRIPTION

The following detailed description is merely exemplary in nature and is not intended to limit the application and uses. Furthermore, there is no intention to be bound by any expressed or implied theory presented in the preceding introduction or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Examples of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that examples of the present disclosure may be practiced in conjunction with any number of systems, and that the systems described herein is merely examples of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an example of the present disclosure.

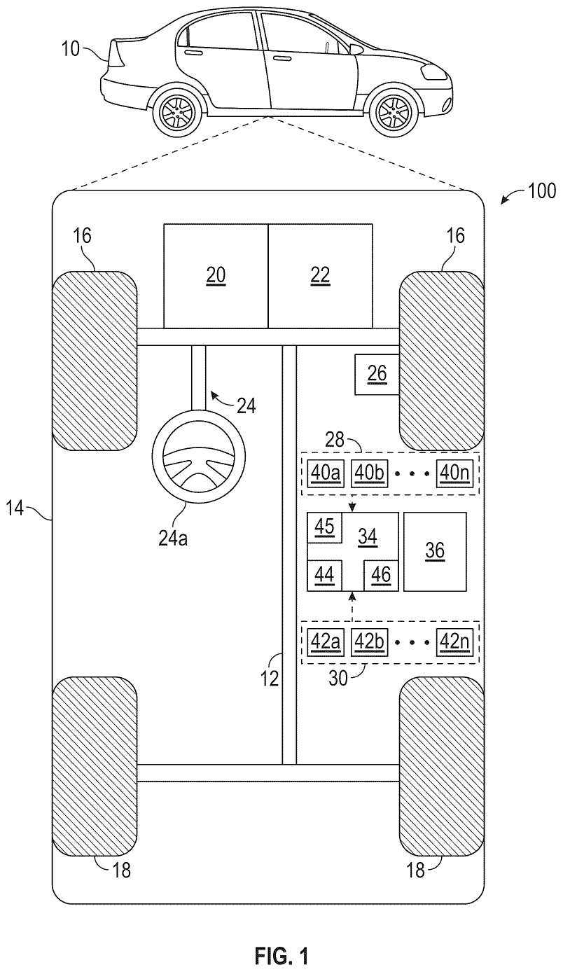

FIG. 1 illustrates a vehicle 10, according to an example. The vehicle 10 includes a complexity score system 100 configured to determine a complexity of an external environment outside of the vehicle 10 that may be used, for example, by other systems of the vehicle 10 for promoting safety and occupant comfort.

In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

The vehicle 10 further includes a propulsion system 20, a transmission system 22, a steering system 24, a sensor system 28, an actuator system 30, at least one data storage device 32, and at least one controller 34. The propulsion system 20 includes an engine and/or motor such as an internal combustion engine (e.g., a gasoline or diesel fueled combustion engine), an electric motor (e.g., a 3-phase AC motor), or a hybrid system that includes more than one type of engine and/or motor. The transmission system 22 is configured to transmit power from the propulsion system 20 to the wheels 16-18 according to selectable speed ratios. According to various examples, the transmission system 22 may include a step-ratio automatic transmission, a continuously-variable transmission, or other appropriate transmission. The steering system 24 influences a position of the wheels 16-18. While depicted as including a steering wheel 24a for illustrative purposes, in some examples contemplated within the scope of the present disclosure, the steering system 24 may not include a steering wheel.

The sensor system 28 includes one or more sensing devices 40a-40n that sense observable conditions of the external environment, the interior environment, and/or a status or condition of a corresponding component of the vehicle 10 and provide such condition and/or status to other systems of the vehicle 10, such as the controller 34. It should be understood that the vehicle 10 may include any number of the sensing devices 40a-40n. The sensing devices 40a-40n can include, but are not limited to, radars, lidars, global positioning systems, optical cameras, thermal cameras, ultrasonic sensors, inertial measurement units, pressure sensors, position sensors, speed sensors, steering wheel angle sensors, and/or other sensors.

The actuator system 30 includes one or more actuator devices 42a-42n that control one or more vehicle features such as, but not limited to, the propulsion system 20, the transmission system 22, and/or the steering system 24.

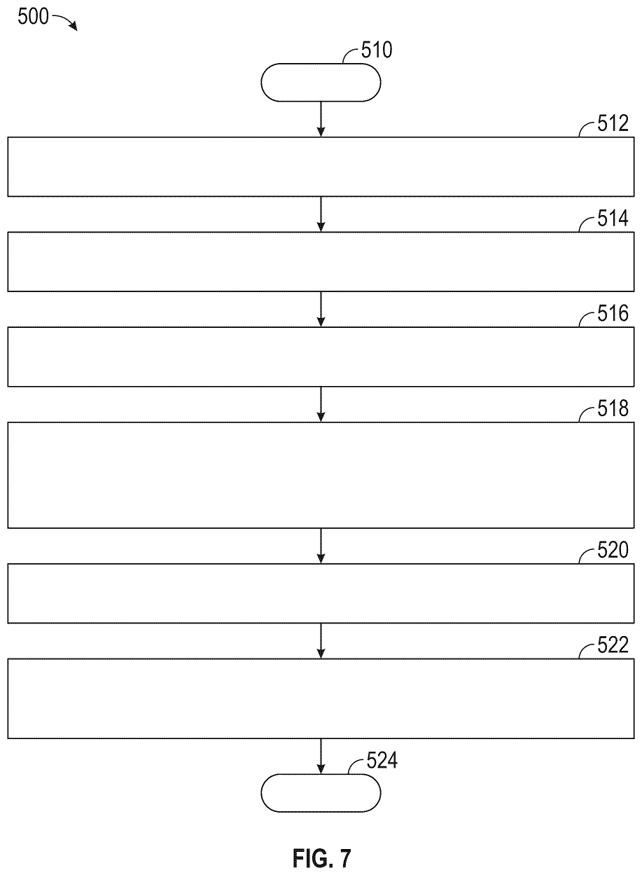

The data storage device 32 stores data for use in controlling the vehicle 10 and/or systems and components thereof. As can be appreciated, the data storage device 32 may be part of the controller 34, separate from the controller 34, or part of the controller 34 and part of a separate system. The storage device 32 can be any suitable type of storage apparatus, including various different types of direct access storage and/or other memory devices. In one example, the storage device 32 comprises a program product from which a computer readable memory device can receive a program that executes one or more examples of one or more processes of the present disclosure, such as the steps of the process discussed further below in connection with FIGS. 7 and/or 8. In another example, the program product may be directly stored in and/or otherwise accessed by the memory device and/or one or more other disks and/or other memory devices.

The controller 34 includes at least one processor 44, a communication bus 45, and a computer readable storage device or media 46. The processor 44 performs the computation and control functions of the controller 34. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (erasable PROM), EEPROMs (electrically erasable PROM), flash memory, or any other electric, magnetic, optical, or combination memory devices capable of storing data, some of which represent executable instructions, used by the controller 34 in controlling the vehicle 10. The bus 45 serves to transmit programs, data, status and other information or signals between the various components of the vehicle 10. The bus 45 can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms, and generate data based on the logic, calculations, methods, and/or algorithms. Although only one controller 34 is shown in FIG. 1, examples of the vehicle 10 can include any number of controllers 34 that communicate over any suitable communication medium or a combination of communication mediums and that cooperate to process the sensor signals, perform logic, calculations, methods, and/or algorithms, and generate data.

As can be appreciated, that the controller 34 may otherwise differ from the example depicted in FIG. 1. For example, the controller 34 may be coupled to or may otherwise utilize one or more remote computer systems and/or other control systems, for example as part of one or more of the above-identified vehicle devices and systems. It will be appreciated that while this example is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 44) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain examples. It will similarly be appreciated that the computer system of the controller 34 may also otherwise differ from the example depicted in FIG. 1, for example in that the computer system of the controller 34 may be coupled to or may otherwise utilize one or more remote computer systems and/or other control systems.

In exemplary implementations, the vehicle 10 is an autonomous vehicle or is otherwise configured to support one or more autonomous or semi-autonomous operating modes, and the complexity score system 100 is incorporated into the vehicle 10. In an exemplary implementation, the vehicle 10 is a so-called Level Two automation system. A Level Two system indicates “partial driving automation,” referring to the driving mode-specific performance by an automated driving system to control steering, acceleration and braking in specific scenarios while a driver remains alert and actively supervises the automated driving system at all times and is capable of providing driver support to control primary driving tasks.

In some an exemplary implementation, the vehicle 10 is a so-called Level Three automation system. A Level Three system indicates “conditional driving automation,” referring to the driving mode-specific performance by an automated driving system to control steering, acceleration and braking in most scenarios while a driver provides driver support to control certain driving tasks.

In some an exemplary implementation, the vehicle 10 is a so-called Level Four automation system. A Level Four system indicates “high driving automation,” referring to the driving mode-specific performance by an automated driving system to control all driving tasks in specific scenarios while a driver optionally provides driver support to control driving tasks.

In some an exemplary implementation, the vehicle 10 is a so-called Level Five automation system. A Level Five system indicates “full driving automation,” referring to the driving mode-specific performance by an automated driving system to control all driving tasks in all scenarios while a driver support is optional but not required.

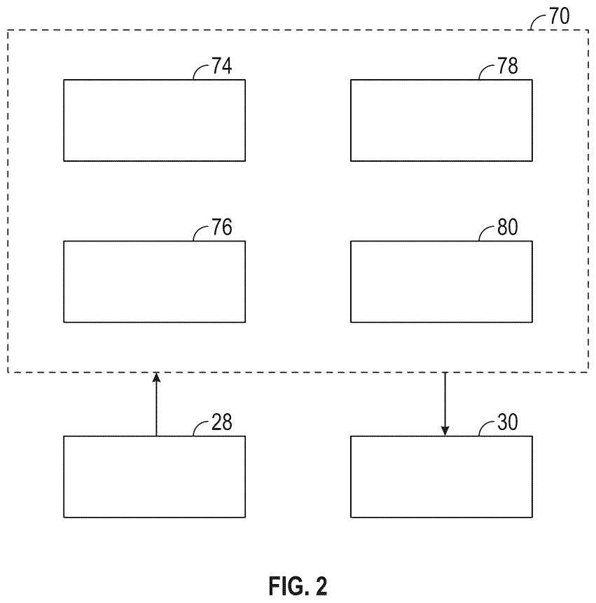

Referring now to FIG. 2, in accordance with various implementations, controller 34 implements an autonomous or semi-autonomous driving system, referred to as an automated driving system (ADS) 70. That is, suitable software and/or hardware components of controller 34 (e.g., processor 44 and computer-readable storage device 46) are utilized to provide the ADS 70 that is used in conjunction with vehicle 10, for example, to automatically control one or more of the actuator devices 42a-42n and thereby control vehicle acceleration, steering, and braking without human intervention.

In various implementations, the instructions of the ADS 70 may be organized by function or system. For example, as shown in FIG. 2, the ADS 70 can include a sensor fusion system 74, a positioning system 76, a guidance system 78, and a vehicle control system 80. As can be appreciated, in various implementations, the instructions may be organized into any number of systems (e.g., combined, further partitioned, etc.) as the disclosure is not limited to the present examples.

In various implementations, the sensor fusion system 74 synthesizes and processes sensor data and predicts the presence, location, classification, and/or path of objects and features of the environment of the vehicle 10. In various implementations, the sensor fusion system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow given the current sensor data and vehicle pose. The vehicle control system 80 then generates control signals for controlling the vehicle 10 according to the determined path. In various implementations, the controller 34 implements machine learning techniques to assist the functionality of the controller 34, such as feature detection/classification, obstruction mitigation, route traversal, mapping, sensor integration, ground-truth determination, and the like.

In one or more implementations, the guidance system 78 includes a motion planning module that generates a motion plan for controlling the vehicle 10 as it traverses along a route. The motion planning module includes a longitudinal solver module that generates a longitudinal motion plan output for controlling the movement of the vehicle 10 along the route in the general direction of travel, for example, by causing the vehicle 10 to accelerate or decelerate at one or more locations in the future along the route to maintain a desired speed or velocity. The motion planning module also includes a lateral solver module that generates a lateral motion plan output for controlling the lateral movement of the vehicle 10 along the route to alter the general direction of travel, for example, by steering the vehicle 10 at one or more locations in the future along the route (e.g., to maintain the vehicle 10 centered within a lane, change lanes, etc.). The longitudinal and lateral plan outputs correspond to the commanded (or planned) path output provided to the vehicle control system 80 for controlling the actuator system 30 to achieve movement of the vehicle 10 along the route that corresponds to the longitudinal and lateral plans.

During normal operation, the longitudinal solver module attempts to optimize the vehicle speed (or velocity) in the direction of travel, the vehicle acceleration in the direction of travel, and the derivative of the vehicle acceleration in the direction of travel, alternatively referred to herein as the longitudinal jerk of the vehicle 10, and the lateral solver module attempts to optimize one or more of the steering angle, the rate of change of the steering angle, and the acceleration or second derivative of the steering angle, alternatively referred to herein as the lateral jerk of the vehicle 10. In this regard, the steering angle can be related to the curvature of the path or route, and any one of the steering angle, the rate of change of the steering angle, and the acceleration or second derivative of the steering angle can be optimized by the lateral solver module, either individually or in combination.

In exemplary implementations, the guidance system 78 supports a hands-free autonomous operating mode that controls steering, acceleration and braking while it is enabled and operating to provide lane centering while attempting to maintain a driver-selected speed and/or following distance (or gap time) relative to other vehicles using the current sensor data (or obstacle data) provided by the sensor fusion system 74 and the current vehicle pose provided by the positioning system 76. In the autonomous operating mode, the guidance system 78 includes or otherwise implements a lane change coordinator that analyzes route information (if available) in addition to data or other information from the sensor fusion system 74, the positioning system 76 and potentially other modules or systems to determine whether or not to initiate and execute a lane change from a current lane of travel to an adjacent lane of travel, for example, based on presence of slower moving traffic within the current lane of travel ahead of the vehicle 10 (e.g., to overtake or pass another vehicle), whether or not the current lane is ending or merging into an adjacent lane, whether a lane change is required to maintain travel along the desired route, and/or the like. In this regard, the lane change coordinator may automatically determine when to initiate a lane change and automatically configure the lateral solver module and/or the motion planning module to generate a corresponding lateral plan to change lanes in the desired manner and provide the lateral plan to the vehicle control system 80, which automatically generates corresponding control signals for autonomously controlling the actuator system 30 to maneuver the vehicle 10 and execute the lane change.

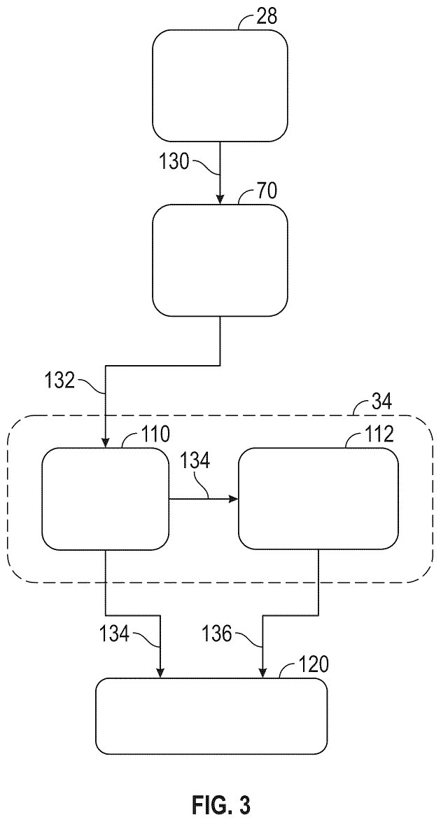

With reference to FIG. 3 and with continued reference to FIGS. 1-2, a dataflow diagram illustrates elements of the complexity score system 100 of FIG. 1 in accordance with various examples. As can be appreciated, various examples of the system 100 according to the present disclosure may include any number of modules embedded within the controller 34 which may be combined and/or further partitioned to similarly implement systems and methods described herein. Furthermore, inputs to the system 100 may be received from other control modules (not shown) associated with the vehicle 10, and/or determined/modeled by other sub-modules (not shown) within the controller 34. Furthermore, the inputs might also be subjected to preprocessing, such as sub-sampling, noise-reduction, normalization, feature-extraction, missing data reduction, and the like. In various examples, the system 100 includes a current scores module 110 and a cumulative scores module 112.

In various examples, the sensor system 28 senses observable conditions exterior to the vehicle 10 and generates sensor data 130 indicative thereof. The ADS 70 may receive the sensor data 130 to perform various autonomous or assisted driving functions. The ADS 70 may generate ADS data 132 indicative of, for example, a vehicle and/or vehicle system state, information indicated from the sensor data 130, and/or other information. In some examples, the ADS data 132 is indicative of various aspects of an external environment outside of the vehicle 10 (e.g., the surroundings). In some examples, the ADS data 132 may be indicative of static and dynamic attributes of a plurality of actors within the external environment. These static and dynamic attributes may include a number of actors, types of actors, and dynamic parameters (e.g., speed, direction, etc.) of the actors. In some examples, the static and dynamic attributes of the actors may include weather conditions, road conditions, capabilities and/or configurations of the vehicle 10. In some examples, the types of actors may include other vehicles, animals, pedestrians, street signs and lights, buildings, medians, barriers, number of lanes or types of roadways, construction zones, etc. In some examples, the dynamic attributes may include speeds of the actors, direction of travel of the actors, capabilities of the actors (e.g., acceleration, turning capabilities, etc.), etc. In some examples, the ADS data 132 may indicate other various information that may be relevant such as visibility of the driver and/or the sensing devices 40a-40n, estimates relating to how quickly the complexity score may change, etc. The ADS 70 may transmit the ADS data 132 to the complexity score system 100, such as the controller 34 thereof.

In various examples, the current scores module 110 receives as input the ADS data 132 generated by the ADS 70. The current scores module 110 processes and analyzes the ADS data 132 to determine one or more current complexity scores in real-time indicative of a complexity of the static and dynamic attributes of the actors in the external environment. In some examples, the current scores module 110 may determine a total complexity score indicative of a complexity of all of the static and dynamic attributes of the actors within a region of interest of the external environment. In some examples, the current scores module 110 may determine various complexity scores indicative of complexities of the static and dynamic attributes of one or more categories of actors.

The region of interest of the external environment may vary depending on the application, configuration, and/or settings of the system 100 and/or the vehicle 10. In some examples, the region of interest may be an entirety of the external environment limited only by the capabilities of the sensor system 28. In other examples, the region of interest may be limited to certain directions relative to the vehicle 10, such as only ahead of the vehicle 10, ahead and to the sides of the vehicle 10, only to the rear of the vehicle 10, to the rear and the sides of the vehicle 10, etc. In some examples, the region of interest may be limited to specific ranges (e.g. 10 meters (m), 20 m, 30 m, etc. around the vehicle 10). In some examples, the region of interest may change based on the conditions of the external environment and/or a state of the vehicle 10. For example, a larger region of interest may be suitable when the vehicle 10 is traveling at relatively high speeds, or when the relative speed between the vehicle 10 and one or more of the actors in the external environment differ significantly. In contrast, a smaller region of interest may be suitable when the vehicle 10 is traveling at slower speeds.

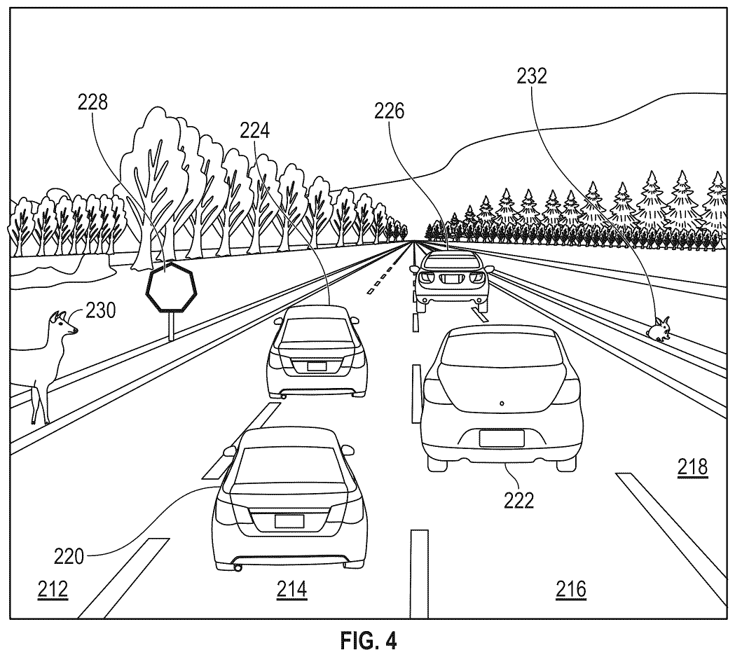

FIGS. 4, 5, and 6 provide nonlimiting examples of external environments and associated exemplary complexity scores as determined by the current scores module 110. In these examples, the complexity scores are represented numerically with lower numbers indicating less complexity and higher numbers indicating more complexity.

Referring initially to FIG. 4, an external environment 200 is depicted that includes a single-direction roadway having four lanes 212, 214, 216, 218 surrounded by open fields and trees. Actors within the external environment include four vehicles 220, 222, 224, 226, one street sign 228, and two animals 230, 232 within a region of interest. Complexity scores may be determined by the current scores module 110. In this example, the complexity scores may include a background complexity score, a car(s) complexity score, and a total complexity score. The background complexity score may consider, for example, the street sign 228, the animals 230, 232, the fields, the trees, and/or weather. The car(s) complexity score may consider, for example, the vehicles 220, 222, 224, 226, their direction of travel, their speed, their position relative to the vehicle 10, their capabilities (e.g., to accelerate, brake, change lanes, etc.), the lanes 212, 214, 216, 218, roadway conditions, weather, etc. The total complexity score is, for example, a sum of the background complexity score and the car(s) complexity score. In this example, the background complexity score may be determined to be 35, the car(s) complexity score may be determined to be 36.5, and the total complexity score may be determined to be 71.5. These complexity scores may be considered relatively low, for example, due to the presence of relatively few cars on the roadway relative to the number of lanes and the relatively few distractions provided by the fields and trees.

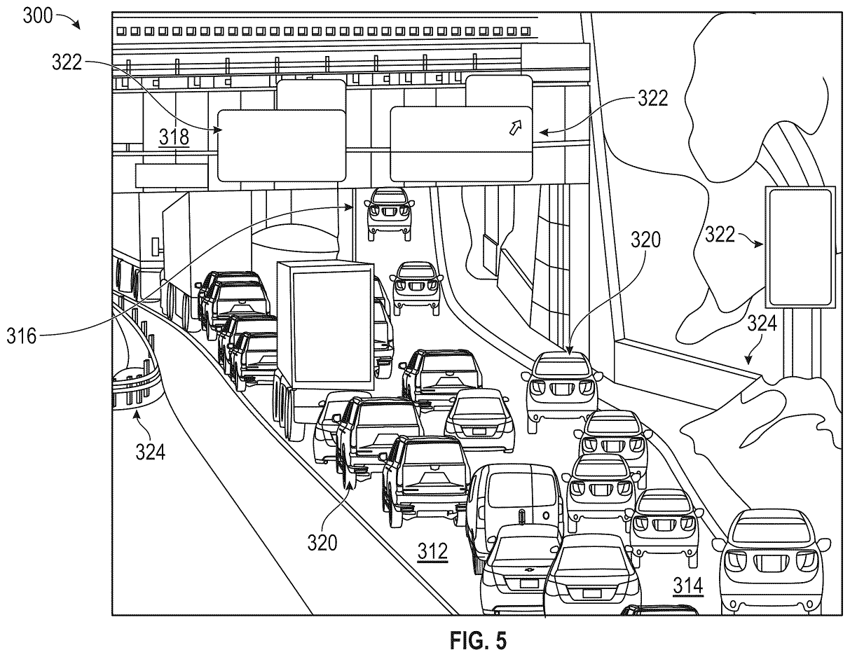

Referring now to FIG. 5, an external environment 300 is depicted that includes a single-direction highway having two lanes 312, 314, and an exit 316 with an overpass 318 overhead. Actors within the external environment 300 include a plurality of vehicles 320, various street signs 322, and barriers 324 within a region of interest. Complexity scores may be determined by the current scores module 110. In this example, the complexity scores may again include the background complexity score, the car(s) complexity score, and the total complexity score. The background complexity score may consider, for example, the overpass 318, the street signs 322, the barriers 324, and/or weather. The car(s) complexity score may consider, for example, the vehicles 320, their direction of travel, their speed, their position relative to the vehicle 10, their capabilities (e.g., to accelerate, brake, change lanes, etc.), the lanes 312, 314, the exit 316, roadway conditions, weather, etc. The total complexity score is again a sum of the background complexity score and the car(s) complexity score. In this example, the background complexity score may be determined to be 70, the car(s) complexity score may be determined to be 150, and the total complexity score may be determined to be 220. These complexity scores may be considered relatively high, for example, due to the presence of the many vehicles 320 in heavy traffic conditions, distractions presented by the street signs 322, and the presence of the exit 316.

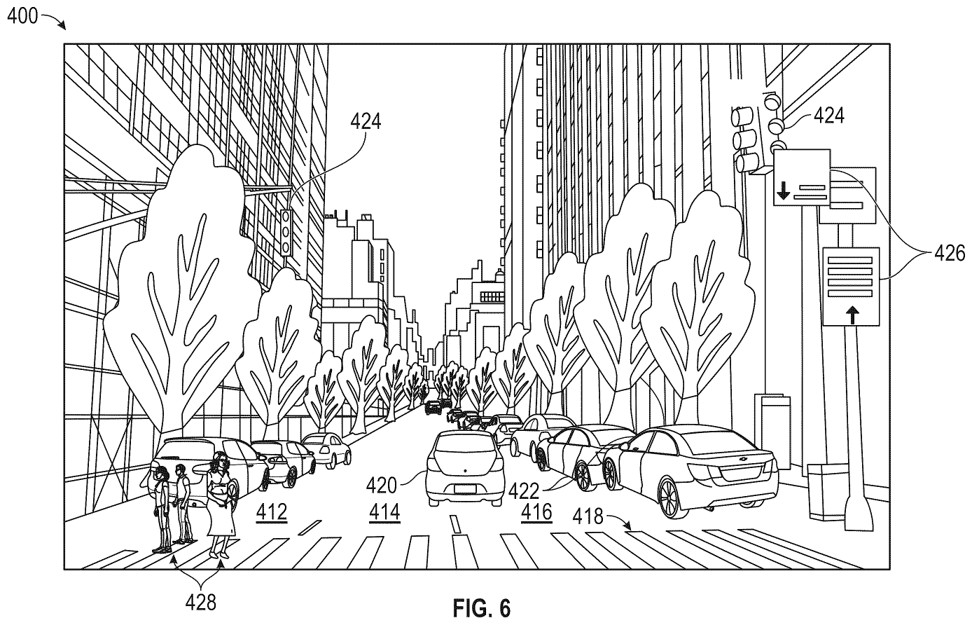

Referring now to FIG. 6, an external environment 400 is depicted that includes a single-direction roadway having three lanes 412, 414, 416, side-street parking, and a crosswalk 418 surrounded by city buildings, construction areas, cross-streets, trees, and other objects common to cities. Actors within the external environment include one moving vehicle 420, a plurality of parked vehicles 422, streetlights 424, street signs 426, and pedestrians 428 within a region of interest. Complexity scores may be determined by the current scores module 110. In this example, the complexity scores may include a human(s) complexity score in addition to the background complexity score, the car(s) complexity score, and the total complexity score. The background complexity score may consider, for example, the streetlights 424, the street signs 426, city buildings, the constructions areas, the trees, and/or weather. The car(s) complexity score may consider, for example, the vehicles 420, 422, their direction of travel, their speed, their position relative to the vehicle 10, their capabilities (e.g., to accelerate, brake, change lanes, etc.), the lanes 412, 414, 416 the side-street parking, roadway conditions, weather, etc. The human(s) complexity score may consider, for example, the crosswalk 418, the number of the pedestrians 428, their direction of travel and position relative to the vehicle 10, their speed, etc. The total complexity score is, for example, a sum of the background complexity score, the car(s) complexity score, and the human(s) complexity score. In this example, the background complexity score may be determined to be 100, the car(s) complexity score may be determined to be 25, the human(s) complexity score may be determined to be 100, and the total complexity score may be determined to be 225. These complexity scores may be considered relatively high, for example, due to the presence of the many distractions provided by the background conditions, and the presence of the pedestrians 428 (who may move in less predictable manners).

In some examples, the complexity scores generated by the systems and methods disclosed herein may be hidden from users of the vehicle 10, and used in the background for modifying the operation of the vehicle 10. In other examples, one or more of the complexity scores may be readily available or even displayed for the user. For example, the complexity score may be displayed on a dashboard or display screen of the vehicle 10. In some examples, the complexity score may be displayed in a manner that emphasizes or highlights the level of complexity. For example, the complexity score may be displayed as a numerical value on a display screen and the numerical value may be color coded to indicate the level of complexity (e.g., a high complexity score may be displayed in red font whereas a low complexity score may be displayed in green font). In some examples, the system 100 may generate a visual, audible, and/or haptic notification or alert for the driver based on the complexity score (e.g., audible alert in response to a high complexity score).

The current scores module 110 may determine the complexity scores in various manners. In some examples, the complexity scores may be determined using one or more weighted product models, additive utility models, normal weighted sum models, ranked weighted sum models, geometric means approach models, non-linear weighted aggregation models, etc. In some examples, generating the complexity score includes inputting the static and dynamic attributes of the actors in the external environment into a weighted sum model. As a nonlimiting example, for actors α_{A}, α_{B}, α_{C} . . . , αₙ on a road, the complexity score may be determined using the weighted sum model represented in equation 1.

$$( {a}_{A} , {a}_{B} , {a}_{C} … , {a}_{n} ) = {\sum }_{i = A}^{n} f ( {Static}_{{a}_{i}} , {Dynamic}_{{a}_{i}} ) \qquad Eq . 1$$

wherein,

$$f ( {Static}_{{a}_{i}} , {Dynamic}_{{a}_{i}} ) = {K}_{{static}_{{1}_{{a}_{i}}}} \cdot {static}_{{1}_{{a}_{i}}} + {K}_{{static}_{{2}_{{a}_{i}}}} \cdot {static}_{{2}_{{a}_{i}}} + ⋯ + {K}_{{dynamic}_{{1}_{{a}_{i}}}} \cdot {dynamic}_{{1}_{{a}_{i}}} + {K}_{{dynamic}_{{2}_{{a}_{i}}}} \cdot {dynamic}_{{2}_{{a}_{i}}} + ⋯ \qquad Eq . 2$$

also expressed as,

$$f ( {Static}_{{a}_{i}} , {Dynamic}_{{a}_{i}} ) = sum ( {\sum }_{j = 1}^{n} {K}_{{static}_{{j}_{{a}_{i}}}} \cdot {static}_{{j}_{{a}_{i}}} , {\sum }_{j = 1}^{n} {K}_{{dynamic}_{{j}_{{a}_{i}}}} \cdot {dynamic}_{{j}_{{a}_{i}}} ) \qquad Eq . 3$$

Referring again to FIG. 3, the current scores module 110 may generate current scores data 134 indicative of the one or more complexity scores determined by the current scores module 110 in real-time. The current scores module 110 may transmit the current scores data 134 to the cumulative scores module 112 and/or other vehicle subsystems 120.

In various examples, the cumulative scores module 112 receives as input the current scores data 134 generated by the current scores module 110. The cumulative scores module 112 may process the current scores data 134 and record the complexity scores and times thereof, for example, in the data storage device 32. The cumulative scores module 112 may analyze the recorded complexity scores and generate a cumulative complexity score indicative of an average of the plurality of complexity scores during a period of time. For example, the cumulative complexity score may indicate an average of the complexity scores recorded for a single trip of the vehicle 10, for a plurality of trips of the vehicle 10 of the same type (e.g., morning commute to driver's job), for a predetermined interval (e.g., last two weeks), for a specific geographic region, and/or for a life of the vehicle 10. The cumulative scores module 112 may generate cumulative scores data 136 indicative of the one or more cumulative complexity scores determined by the cumulative scores module 112. The cumulative scores module 112 may transmit the cumulative scores data 136 to the other vehicle subsystems 120.

The cumulative scores module 112 may determine the cumulative complexity scores in various manners. In some examples, generating the cumulative complexity scores may be as represented in equation 4.

$$Cumulative Complexity Score ( {c}_{A} , {c}_{B} , {c}_{C} … , {c}_{n} ) = ∅ ( {c}_{A} , {c}_{B} , {c}_{C} … , {c}_{n} ) \qquad Eq . 4$$

where c is an individual complexity score generated at periodic intervals or in response to predetermined events by the current scores module 110 and recorded for use by the cumulative scores module 112.

The current scores data 134 and the cumulative scores data 136 may be used by the other vehicle subsystems 120 for various purposes including, for example, to modify operation of the vehicle 10. For example, complexity scores may be compared to various thresholds and may result in modifications to autonomous vehicle speeds, acceleration, maintained distance from other vehicles, braking rate, path planning, available actions, etc. In some examples, the complexity scores may be considered in determining which autonomous and/or driving assistance modes are available. For example, a hands-off driving mode may be unavailable while current complexity scores are above a threshold.

In some examples, the current scores data 134 and/or the cumulative scores data 136 may be recorded for future use by one or more systems of the vehicle 10. For example, the current and/or cumulative scores may be recorded along with the position of the vehicle at the time of generation and/or the time of day. Such information may be subsequently used, for example, by a navigation system for planning routes to destinations with consideration of environmental complexities along the available routes, by a braking system to improve braking in highly complex environments (e.g., braking controls can be made more responsive in highly complex environment like city downtowns by adjusting braking calibrations to prioritize safety over comfort), by vehicle operation modes to promote intended performance for environments that with different complexities (e.g., performance modes like sports mode can be activated in low complexity environment and by leveraging data analytics sub-system in the complexity score system).

In some examples, one or more of the complexity scores may be provided to a systematic positive reinforcement system of the vehicle 10 to promote specific driver behavior. As used herein, a systematic positive reinforcement system refers to a system that provides a structured method of providing rewards or incentives to reinforce specific behaviors or actions associated with the vehicle's operation or user interaction. For example, the positive reinforcement system may provide driver behavior feedback, for example, by providing visual or auditory rewards (e.g., a congratulatory message, a score, or positive sounds) when the driver performs safe or environmentally friendly actions. As another example, the positive reinforcement system may provide real-time feedback (e.g., via the dashboard or an app) indicating an assessment of the driving behavior and/or offering rewards such as points or discounts on future services (e.g., discounts for vehicle maintenance, charging stations, or insurance). In regard to the complexity scores, the positive reinforcement system may provide incentives or rewards for specific driving behaviors such as reducing speed or maintaining a greater distance from other vehicles when the complexity scores are relatively high.

With reference now to FIG. 7 and with continued reference to FIGS. 1-6, a flowchart provides a method 500 for generating complexity scores for a vehicle, for example, as performed by the system 100, in accordance with various examples. As can be appreciated in light of the disclosure, the order of operation within the method 500 is not limited to the sequential execution as illustrated in FIG. 7, but may be performed in one or more varying orders as applicable and in accordance with the present disclosure. In various examples, the method 500 can be scheduled to run based on one or more predetermined events, and/or can run continuously during operation of the vehicle 10.

In one example, the method 500 may start at 510. At 512, the method 500 may include receiving sensor data indicative of an external environment outside of a vehicle. The sensor data may be sensed and transmitted from various sensing devices of a sensor system onboard the vehicle. At 514, the method 500 may include processing static and dynamic attributes of actors in the external environment based on the sensor data. In some examples, the sensor data may be received and processed by an ADS of the vehicle, by a complexity score system of the vehicle, or both. At 516, the method 500 may include generating a complexity score indicative of a complexity of the static and dynamic attributes of the actors in the external environment. At 518, the method 500 may optionally include recording complexity score data indicative of a plurality of complexity scores periodically generated over a period of time indicative of the complexity of the static and dynamic attributes of the actors in the external environment at the time of generation thereof. At 520, the method 500 may optionally include generating a cumulative complexity score indicative of an average of the plurality of complexity scores during the period of time. At 522, the method 500 may include providing the complexity score (and optionally the cumulative complexity score) to one or more other systems of the vehicle to modify operation of the vehicle based on the complexity score (and/or optionally the cumulative complexity score). The method 500 may end at 524.

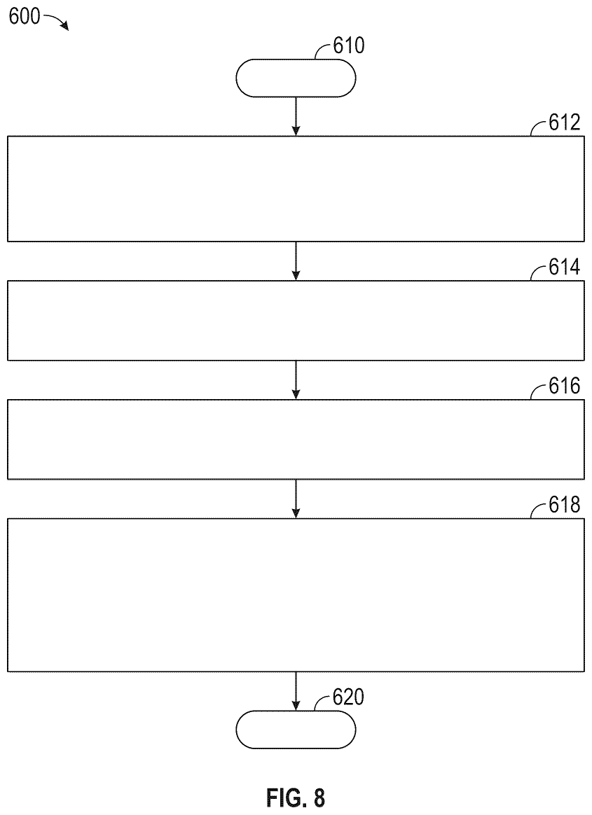

With reference now to FIG. 8 and with continued reference to FIGS. 1-7, a flowchart provides a method 600 for testing an ADS of a vehicle, for example, as performed by the system 100, in accordance with various examples. As can be appreciated in light of the disclosure, the order of operation within the method 600 is not limited to the sequential execution as illustrated in FIG. 8, but may be performed in one or more varying orders as applicable and in accordance with the present disclosure. In various examples, the method 600 can be scheduled to run based on one or more predetermined events, and/or can run continuously during operation of the vehicle 10.

In one example, the method 600 may start at 610. At 612, the method 600 may include generating models of driving external environments or scenarios for use in testing an ego-vehicle. As used herein, an ego-vehicle refers to a vehicle under consideration or observation in a given scenario. In other words, the ego-vehicle is the vehicle being tested or observed in the simulated environment. Other objects, such as other vehicles, pedestrians, traffic lights, etc., may be modeled as part of the driving external environments or scenarios. In various examples, the external environment may include a plurality of agents or actors having static and dynamic attributes. At 614, the method 600 may include generating a complexity score indicative of the complexity of the static and dynamic attributes of the actors in the external environment for each of the driving scenarios.

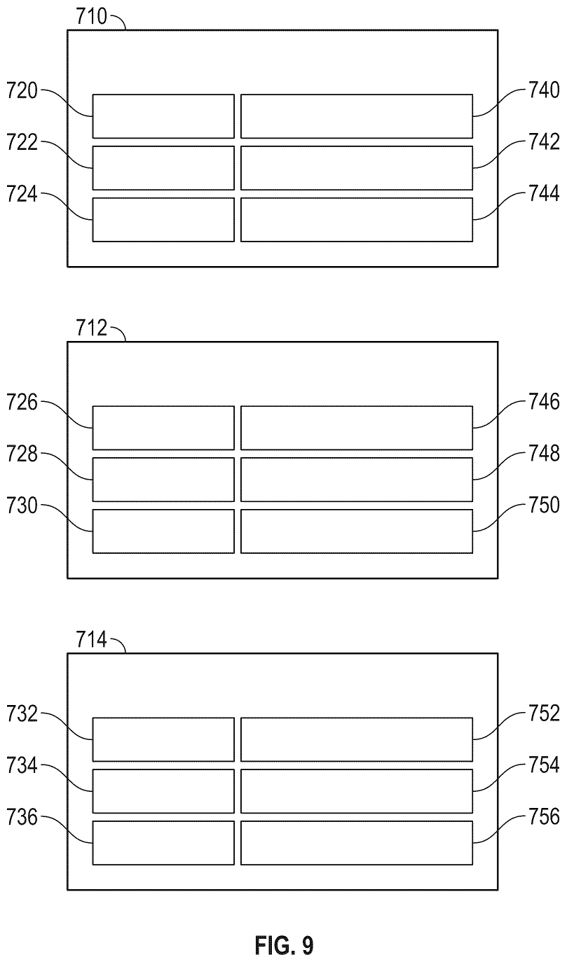

At 616, the method 600 may include assigning each of the driving scenarios to a corresponding one of two or more categories (e.g., “bins” or “buckets”) based on the corresponding complexity score of each of the driving scenarios. For example, FIG. 9 schematically represents various scenarios 720-736 and corresponding complexity scores 740-756 grouped into categories 710-714. In this example, the categories 710-714 include a low complexity score category 710, a medium complexity score category 712, and a high complexity score category 714. It should be noted that any number of categories may be used, categories may be differentiated by various parameters, and each of the scenarios and their complexity scores may be included in any number of the categories. For example, a specific scenario may be included in a first category based on its complexity score being within a range assigned to the first category (e.g., a medium score within a medium score category), and also included in a second category based on parameters of the scenario (e.g., heavy traffic within a heavy traffic scenario). At 618, the method 600 may include performing a simulation test using one of the categories in order to test an ADS or autonomous driving features of the ego-vehicle to evaluate performance of such systems or features. For example, the simulation test may evaluate the ego-vehicle's behavior under different traffic conditions associated with the category to test how well the systems or features handle scenarios of the type assigned to the category. In this manner, a system or feature may be tested for various scenarios in a single test of the corresponding category, as the performance of the system or feature may be representative of the performance of thereof in each of the driving scenarios assigned to the category. The method 600 may end at 620. In some examples, the cumulative scores can be used for testing purposes. For example, long-term simulations, in the form of videos or similar formats, and their respective cumulative scores can be bucketed into different complexity buckets and used for ADS software testing. This may be similar to real world simulation as opposed to single frame complexity score testing.

The systems and methods disclosed herein provide various benefits over certain existing systems and methods. For example, generating and using the complexity scores provides for quantification of external factors in real-time, with specific applications to other systems of the vehicle. This provides for an accurate assessment of the impact of external factors and provides valuable insights for enhancing vehicle performance and safety. These systems and methods may capture the demanding conditions surrounding a vehicle and enhance driving productivity promoting vehicle performance and driver focus. For vehicle system testing, the systems and methods provide for a metric that quantifies complexity and thereby may improve benchmarking for ADS performance evaluation and simplification of testing for ADS systems.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method, comprising:
receiving, with a controller having one or more processors, sensor data indicative of an external environment outside of a vehicle;
processing, with the one or more processors of the controller, static and dynamic attributes of actors in the external environment based on the sensor data;
generating, with the one or more processors of the controller, a complexity score indicative of a complexity of the static and dynamic attributes of the actors in the external environment; and
providing, with the one or more processors of the controller, the complexity score to one or more other systems of the vehicle to modify operation of the vehicle based on the complexity score.

2. The method of claim 1, wherein generating the complexity score includes inputting the static and dynamic attributes of the actors in the external environment into a weighted sum model.

3. The method of claim 1, wherein the static and dynamic attributes of the actors include a number, type, and dynamic parameters of the actors in the external environment.

4. The method of claim 3, wherein the static and dynamic attributes of the actors include weather conditions.

5. The method of claim 1, further comprising:
recording complexity score data indicative of a plurality of complexity scores periodically generated over a period of time indicative of the complexity of the static and dynamic attributes of the actors in the external environment at a time of generation thereof; and
generating, with the one or more processors of the controller, a cumulative complexity score indicative of an average of the plurality of complexity scores during the period of time.

6. The method of claim 1, further comprising providing, with the one or more processors of the controller, the complexity score to a systematic positive reinforcement system of the vehicle to promote specific driver behavior.

7. The method of claim 1, wherein processing the static and dynamic attributes of the actors is performed with an automated driving system (ADS) of the vehicle.

8. The method of claim 1, further comprising providing, with the one or more processors of the controller, the complexity score to an automated driving system (ADS) of the vehicle for path planning of the vehicle.

9. A method, comprising:
generating, with one or more processors, models of driving scenarios that include a vehicle traveling through an external environment outside of the vehicle, wherein the external environment includes a plurality of actors having static and dynamic attributes;
generating, with the one or more processors, complexity scores indicative of complexities of the static and dynamic attributes of the plurality of actors in the external environment for each of the driving scenarios;
assigning, with the one or more processors, each of the driving scenarios to a corresponding one of two or more categories based on the corresponding complexity scores of each of the driving scenarios; and
performing, with the one or more processors, a vehicle simulation test using a first category of the two or more categories in order to test an automated driving system (ADS) of the vehicle to evaluate performance of the ADS, wherein the performance of the ADS in the vehicle simulation test is representative of the performance of the ADS in each of the driving scenarios assigned to the first category.

10. The method of claim 7, wherein generating the complexity score includes inputting the static and dynamic attributes of the plurality of actors in the external environment into a weighted sum model.

11. The method of claim 7, wherein the static and dynamic attributes of the plurality of actors include a number, type, and dynamic parameters of the plurality of actors in the external environment.

12. The method of claim 9, wherein the static and dynamic attributes of the plurality of actors include weather conditions.

13. The method of claim 7, further comprising modifying the ADS of the vehicle based on the performance of the ADS in the vehicle simulation test.

14. The method of claim 7, wherein the two or more categories have different ranges of complexity scores associated therewith and each of the driving scenarios is assigned to one of the two or more categories for which the corresponding complexity score of the driving scenarios falls within the associated range.

15. A system for a vehicle, comprising:
a sensor system including sensing devices configured to sense observable conditions in an external environment outside of the vehicle; and
a controller in operable communication with the sensor system, wherein the controller is configured to, by one or more processors:
receive, from the sensor system, sensor data indicative of the observable conditions in the external environment;
process the sensor data to determine static and dynamic attributes of actors in the external environment;
generate a complexity score indicative of a complexity of the static and dynamic attributes of the actors in the external environment; and
provide the complexity score to one or more other systems of the vehicle to modify operation of the vehicle based on the complexity score.

16. The system of claim 11, wherein the controller is configured to, with the one or more processors, generate the complexity score by inputting the static and dynamic attributes of the actors in the external environment into a weighted sum model.

17. The system of claim 11, wherein the static and dynamic attributes of the actors include a number, type, and dynamic parameters of the actors in the external environment.

18. The system of claim 13, wherein the static and dynamic attributes of the actors include weather conditions.

19. The system of claim 11, wherein the controller is configured to, with the one or more processors:
record complexity score data indicative of a plurality of complexity scores periodically generated over a period of time indicative of the complexity of the static and dynamic attributes of the actors in the external environment at a time of generation thereof; and
generate a cumulative complexity score indicative of an average of the plurality of complexity scores during the period of time.

20. The system of claim 11, wherein the controller is configured to, with the one or more processors, provide the complexity score to a systematic positive reinforcement system of the vehicle to promote specific driver behavior.
